(19) United States
(12) Patent Application Publication
(10) Pub. No.: US 2004/0064829 A1
(43) Pub. Date: Apr. 1, 2004

(54) Method for identifying processor affinity and improving software execution

(76) Inventors: Kim Pallister, Beaverton, OR (US); Dean P. Macri, Beaverton, OR (US)

Correspondence Address: Michael J. Mallie, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/262,353

(22) Filed: Sep. 30, 2002

(51) Int. Cl. G06F 9/44; G06F 9/46

(52) U.S. Cl. 719/327; 719/328

(57) ABSTRACT

A method and an apparatus for identifying a processing configuration, identifying a piece of application software, and using processor affinity information from an affinity database to determine which processor(s) or duplicated component(s) of a processor to use in executing the piece of application software.

### FIELD OF THE INVENTION

A method and an apparatus for identifying the affinity of software for being executed by a processor and improving the execution of that software is disclosed.

### ART BACKGROUND

The continuing pace of development in microprocessors has continued a trend of offering users of commonly available personal computer systems ever greater levels of processing capability at ever lower cost. As part of this trend, personal computer systems with multiple processors and/or processors with duplicated components that provide functionality akin to multiple processors are becoming available.

Unlike typical multi-user computer systems, such as servers, minicomputers, mainframes, supercomputers, etc., that tend to be operated or at least overseen by personnel skilled in technical aspects of those computer systems, personal computer systems are typically owned and operated by members of the general public, the majority of whom are not nearly so skilled. This comparative lack of skill on the part of the general public can bring about difficulties in transitioning between different personal computer systems having different configurations of multiple processors and/or processors with duplicated components.

Software originally written and/or tested with one given configuration of multiple processors and/or processors with duplicated components can function inconsistently and/or function poorly with a different configuration of multiple processors and/or processors with duplicated components. In the case of multi-user computer systems operated or at least overseen by skilled personnel, the skilled personnel tend to understand the need to ensure that software being transferred between computer systems with different configurations of multiple processors and/or processors with duplicated components. There are also unfortunate cases of software being developed for a given configuration of multiple processors and/or processors with duplicated components where the software is not tested adequately or at all with a given configuration before being released for use. Skilled personnel would tend to recognize such situations upon encountering them.

However, members of the general public usually do not appreciate these aspects of software. Indeed, many members of the general public actually have no idea what type or combination of processors are used in their personal computer systems. Members of the general public may, therefore, find themselves very unpleasantly surprised as they attempt to move familiar pieces of software from one personal computer system to another. They may find themselves confronted with inconsistent function or reduced levels of performance in executing the software, even where familiar pieces of software have been moved to what is known to be a faster performing personal computer system.

Over time, such software may be supplemented with patches and/or replaced with newer versions of such software to take into account specific types or configurations of processors to alleviate such problems. However, the creation of such patches and newer versions requires time such that neither option may be available when a member of the general public discovers the need for it. Also, even where such options do exist, it would still be preferable to provide a way by which a member of the general public could continue to use the software they already have without incurring the time, effort and/or expense of acquiring and making use of such patches and/or newer versions.

### BRIEF DESCRIPTION OF THE DRAWINGS

The objects, features, and advantages of the invention as hereinafter claimed will be apparent to one skilled in the art in view of the following detailed description in which:

FIG. 1 shows an embodiment of a computer system running a piece of application software.

FIG. 2 shows another embodiment of a computer system running a piece of application software.

FIG. 3 shows yet another embodiment of a computer system running a piece of application software.

FIG. 4 is a flow chart of an embodiment of the start of execution of a piece of application software.

FIG. 5 is a flow chart of another embodiment of the start of execution of a piece of application software.

### DETAILED DESCRIPTION

Although numerous details are set forth for purposes of explanation and to provide a thorough understanding in the following description, it will be apparent to those skilled in the art that these specific details are not required in order to practice embodiments of the invention as hereinafter claimed.

A method and an apparatus for identifying affinity of application software for processors and improving the execution of application software for a plurality of possible processing configurations are disclosed. Specifically, an embodiment identifies the affinity of a piece of application software at the time that execution of that application software on a given computer system is to begin to determine how best to allocate portions of that application software among the processors and/or processor components available in that computer system.

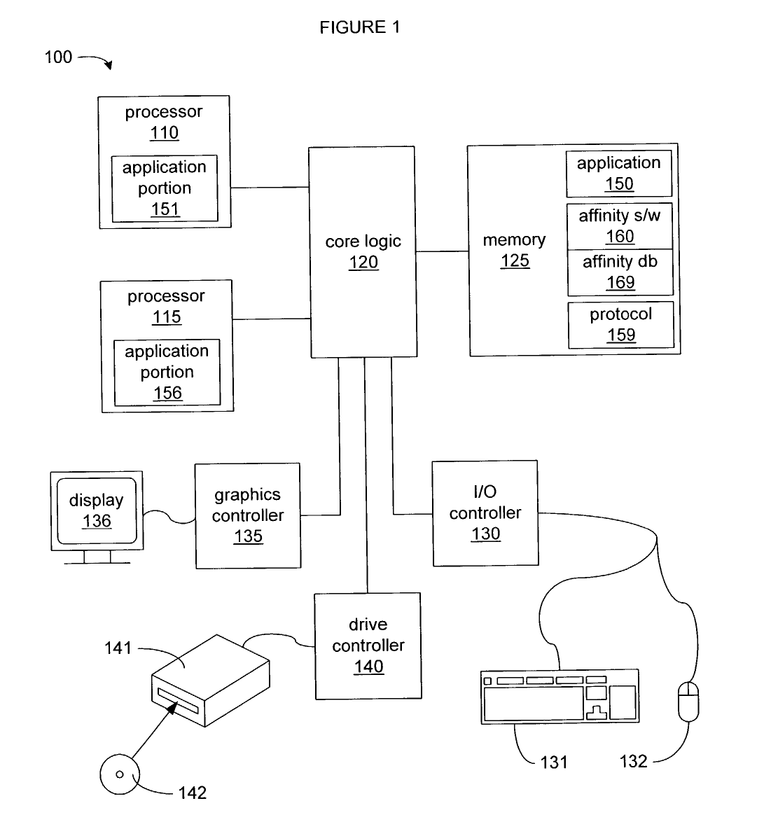

FIG. 1 shows an embodiment of a computer system running a piece of application software. Computer system 100 includes processors 110 and 115, both of which are coupled to memory 125, I/O controller 130, graphics controller 135 and bus controller 140 through core logic 120. Core logic is a combination of logic circuits and/or busses used to provide this coupling, and as those skilled in the art will readily appreciate, many different variations of logic circuits and busses making up core logic 120 may be resorted to without departing from the scope of the present invention as claimed. I/O controller 130 is depicted as being further coupled to keyboard 131 and mouse 132, graphics controller 135 is depicted as being further coupled to display 136, and drive controller 140 is depicted as being further coupled to storage media device 141 which is configured to work with storage media 142.

Processors 110 and 115 provide a processing configuration made up of two separate processors, i.e., two processors that do not share the same instruction queues, execution units, cache, etc. It is likely that in a typical computer system, processors 110 and 115 are sufficiently independent that each would exist within a physically separate integrated circuit package and may each be coupled to core logic 120 by way of separate busses.

Within memory 125 is stored at least a portion of application software 150, as well as at least a portion of affinity software 160 along with at least a portion of affinity database 169. In some embodiments, affinity software 160 may be integrated as part of an operating system, while in other embodiments, affinity software may be acquired and/or installed in computer system 100 separately from an operating system. At some time during the operation of computer system 100, computer system 100 is caused to begin execution of a portion of affinity software 160 to identify the particular processing configuration created by the combination of processors 110 and 115. In some embodiments, the execution of this portion of affinity software 160 may be carried out as computer system 100 is initialized or “booted” so that the identification of the processing configuration is carried out long before any application software, such as application software 150, is executed.

Also at some time during the operation of computer system 100, computer system 100 is caused to begin execution of application software 150. At the time of the beginning of the execution of application software 150, computer system 100 is caused to also begin execution of another portion of affinity software 160 to identify application software 150 and to then search affinity database 169 to find an entry corresponding to the identity of application software 150 among a plurality of entries corresponding to various pieces of application software. Upon finding an entry corresponding to application software 150, computer system 100 is caused by affinity software 160 to use the information within that entry to determine the manner in which application software 150 should be executed within computer system 100 given the processing configuration created by the combination of processors 110 and 115. Specifically, the information within that entry is used to determine whether application software 150 should be executed by processor 110, processor 115 or both processors.

If it is determined that application software 150 should be executed in only one or the other of processors 110 or 115, then one or the other of processors 110 or 115 will read at least a portion of application software 150 from memory 125, keeping portion 151 or 156, respectively, in an instruction queue, cache, and/or registers to be executed. If it is determined that application software 150 should be executed by both processors 110 and 115, then both processors 110 and 115 will read at least a portion of application software 150, keeping portions 151 and 156, respectively, to be executed, as well as writing to and reading from protocol area 159 within memory 125. Protocol area 159 within memory 125 is where semaphores, software flags and/or other pieces of data used to coordinate the execution of portions of application software 150 between processors 110 and 115 so that portions of application software 150 are executed in a specific order where required, i.e., dependencies between portions of application software 150 are correctly maintained.

In one embodiment, after the determination of which of processors 110 and 115 should be used in executing application software 150 and if affinity software 160 is integrated within an operating system, then that operating system may carry out controlling which of processors 110 and 115 are used in executing application software 150. In another embodiment, if affinity software 160 is not integrated within an operating system, then affinity software 160 may signal an operating system as to which ones of processors 110 and 115 should be used in executing application software 150. In still another embodiment, and regardless of whether affinity software 160 is integrated within an operating system or not, affinity software 160 may directly signal application software 150 as to which ones of processors 110 and 115 should be used to execute application software 150.

Affinity database 169 provides information on known preferred matches of various pieces of application software to various processing configurations. It may be that for computer systems having two or more separate processors, such as computer system 100 of FIG. 1, some application can be executed with better performance using only one processor, while other application can be executed with better performance using more than one or even all available processors. In one embodiment, database 169 is created from information derived from testing the execution of application software, such as application software 150, in a variety of different ways and on a variety of different processing configurations in an effort to establish by experimentation the manner in which each piece of application software is best executed on each processing configuration tested. Alternatively, database 169 may be created from information derived from calculations of parameters of various pieces of application software and various processing configurations in lieu of or in conjunction with actual testing.

In one embodiment, affinity database 169 is a single database providing matches between various pieces of application software and various processing configurations. In another embodiment, affinity database 169 is subdivided into smaller portions, each of which is associated with a particular processing configuration. As discussed earlier, it may be that the execution of a portion of affinity software 160 to identify the processing configuration may take place at the time when computer system 100 is initialized. In that case, it may be that only a portion of affinity database 169 is actually ever loaded into memory 125, since other portions concerning other processing configurations not found in computer system 100 would never be used. However, if the execution of a portion of affinity software 160 to identify the processing configuration does not occur until the time that application software 150 is also to be identified by executing another portion of affinity software 160, then it may be that more of affinity database 169 is loaded into memory 125 so that information on multiple processing configurations is made more readily available.

As discussed above, execution of the portion of affinity software 160 to identify application software 150 begins at the time of the beginning of the execution of application software 150. In one embodiment, affinity software 160 provides a user interface, such as an onscreen menu, that a user of computer system 100 uses to cause the beginning of the execution of application software 150. In essence, in this embodiment, the user begins the execution of application software 150 through affinity software 160, and in so doing, the user identifies application software 150 to affinity software 160 by way of selecting application software 150. This would allow affinity software 160 to obtain the identity of application software 150 just before application software 150 is executed. The searching of affinity database 169 and the determining of which ones of processors 110 and 115 on which application software should be executed could also be done just before application software 150 is executed, so that the earlier discussed signals could be sent to an operating system and/or application software 150 as appropriate.

In another embodiment, affinity software 160 is either integrated within an operating system or is in communication with an operating system, and affinity software 160 identifies application software from information acquired through the operating system when the user interface of the operating system is used by a user of computer system 100 to select application software 150 to be executed. In this other embodiment, it may be that the operating system cooperates with affinity software 160 so that execution of application software 150 does not actually take place until application software 150 is identified, and perhaps additionally, not until the searching of affinity database 169 and the determining of which ones of processors 110 and 115 on which to execute application software 150 is carried out. Alternatively, in this other embodiment, it may be that some degree of execution of application software 150 is allowed to proceed before affinity software 160 identifies application software 150, and that the execution of application software 150 is adjusted or altered to change which ones of processors 110 and 115 on which application software 150 is executed at a later point. This may be the case where an operating system does not provide a way for the execution of application software 150 to be entirely prevented before being identified, or where allowing application software 150 to begin to be executed is necessary to obtain information needed to be identified.

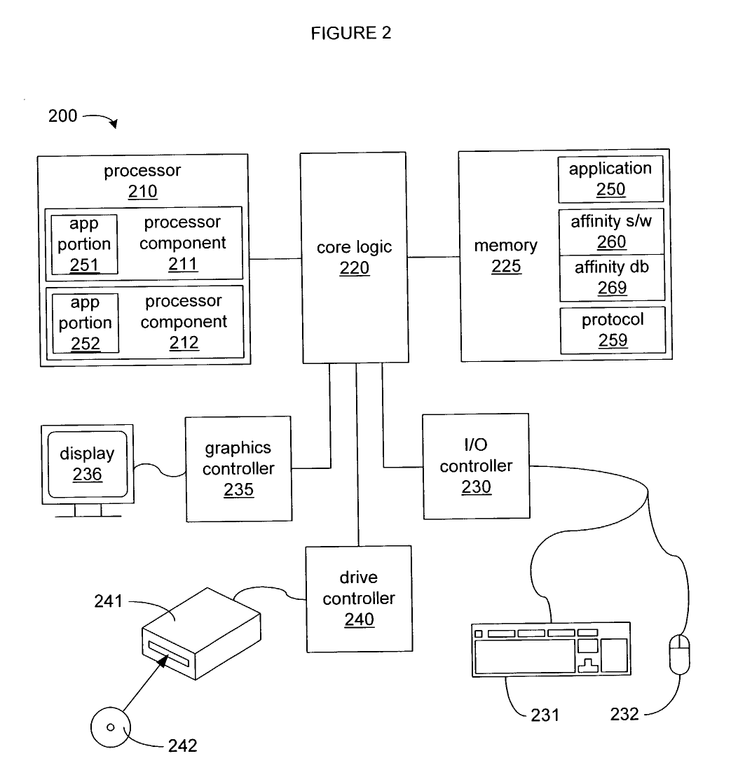

FIG. 2 shows another embodiment of a computer system running a piece of application software. In a manner largely corresponding to computer system 100 of FIG. 1, computer system 200 includes processor 210 coupled to memory 225, I/O controller 230, graphics controller 235 and bus controller 240 through core logic 220. I/O controller 230 is depicted as being further coupled to keyboard 231 and mouse 232, graphics controller 235 is depicted as being further coupled to display 236, and drive controller 240 is depicted as being further coupled to storage media device 241 which is configured to work with storage media 242.

Processor 210 has duplicated components 211 and 212 that allow processor 210 to execute software in a way not unlike two separate processors, such as processors 110 and 115 of FIG. 1. As those skilled in the art will appreciate, a wide variety of components within a processor may be duplicated, and the exact choice of which components are duplicated and which are not is beyond the spirit and scope of the present invention as hereinafter claimed. In one embodiment, at least a portion of the instruction queue of processor 210 is duplicated or is at least a single instruction queue capable of functioning as if it were duplicated, to allow two independent sequences of instructions or “threads” to be executed within processor 210 in a manner substantially similar to a pair of separate processors in a multiprocessor computer system. In other embodiments, provision is made for executing two independent sequences of instructions through duplicated processor registers, duplicated instruction and/or data caches, and/or other duplicated components either in addition to or in lieu of duplicated instruction queues.

Regardless of the exact choice of components duplicated, processor 210 provides a processing configuration made up of one processor with a behavior substantially like that of two separate processors. Although the duplication of components, generally speaking, would tend to improve the performance of processor 210 in executing a piece of application software written with the intention of being executed in a multiprocessor computer system, the exact choice of what components of processor 210 are duplicated could result in inconsistent or poor performance of application software executed using both duplicates of each duplicated components. In other words, where a piece of application software was originally written to be executed with good performance in a computer system with two processors, it may be that not enough components or a less than favorable choice of components being duplicated within processor 210 results in the same application software being executed with performance that is not only worse than with two truly independent processors, but possibly even worse than in a computer system with a single processor that has no duplicated components. Causes of this may include, but are not limited to, having two independent sequences of instructions making requests for data from memory that are sufficiently discontiguous that efficient prefetching of instructions, branch prediction and/or cache prediction is not possible.

However, the opposite situation could also occur in that a piece of application software written to be executed with good performance in a computer system with two processors may show better performance when executed by a single processor with duplicated components, depending on the characteristics of that software and the choice of duplicated components. Causes of this may include, but are not limited to, more rapid availability of values between duplicated sets of registers, recurring instances where cache fills or prefetching results in more rapid availability of data from memory for both sequences of instructions being executed, etc.

Therefore, as action by a user of computer system 200 or other stimulus causes the beginning of the execution of application software 250, execution of affinity software 260 also begins. The beginning of execution of affinity software 260 at that time may commence with the identification of the processing configuration, unless this was already done at an earlier time in a manner corresponding to the earlier discussion of affinity software 160, such as when computer system 200 was initialized. The beginning of execution of affinity software 260 also causes the identification of application software 250 and a search in affinity database 269 for an entry corresponding to application software 250.

The information within that entry in affinity database 269 is used to determine whether application software 250 should be executed by processor 210 in a manner similar to that of a processing configuration with two separate processors by using both of duplicated processor components 211 and 212, or by using only one or the other of processor components 211 and 212. If it is determined that application software 250 should be executed using only one or the other of processor components 211 or 212, then processor 210 will read at least a portion of application software 250 from memory 225, keeping either application software portion 251 or 252 in an instruction queue, cache, and/or registers in processor component 211 or 212, respectively, to be executed. If it is determined that application software 250 should be executed using both of processor components 211 and 212, then processors 210 will read at least a portion of application software 250, keeping application portions 251 and 252, respectively, to be executed, as well as writing to and reading from protocol area 259 within memory 225.

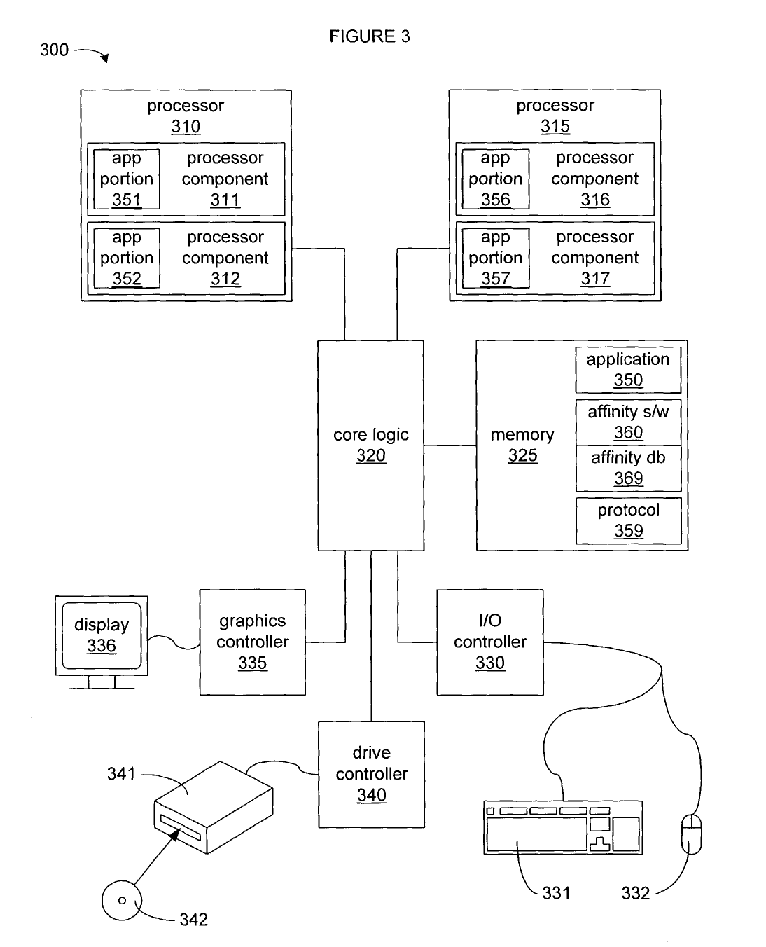

FIG. 3 shows yet another embodiment of a computer system running a piece of application software. In a manner largely corresponding to computer system 100 of FIG. 1, computer system 300 includes processors 310 and 315 coupled to memory 325, I/O controller 330, graphics controller 335 and bus controller 340 through core logic 320. I/O controller 330 is depicted as being further coupled to keyboard 331 and mouse 332, graphics controller 335 is depicted as being further coupled to display 336, and drive controller 340 is depicted as being further coupled to storage media device 341 which is configured to work with storage media 342.

Processor 310 has duplicated processor components 311 and 312, and processor 315 has duplicated processor components 316 and 317, that allow each of processors 310 and 315 to execute software in a way not unlike two separate processors, very much like processor 210 of FIG. 2. Just as was the case regarding processor 210 of FIG. 2, a wide variety of components within each of processors 310 and 315 may be duplicated, and the exact choice of which components are duplicated and which are not is beyond the spirit and scope of the present invention as hereinafter claimed.

Regardless of the exact choice of components duplicated, processors 310 and 315 provide a processing configuration made up of two processors, each of which having a behavior substantially like that of two separate processors. As with processor 210 of FIG. 2, although this duplication of components, generally speaking, would tend to improve the performance of each of processors 310 and 315 in executing a piece of application software written with the intention of being executed in a multiprocessor computer system, the exact choice of what components of processors 310 and 315 are duplicated could result in inconsistent or poor performance of application software executed using both duplicates of each duplicated components. Alternatively, as with processor 210 of FIG. 2, another piece of application software written with the intention of being executed in a multiprocessor computer system, the exact choice of duplicated components could result in better performance.

Therefore, as action by a user of computer system 300 or other stimulus causes the beginning of the execution of application software 350, execution of affinity software 360 also begins. The beginning of execution of affinity software 360 at that time may commence with the identification of the processing configuration, unless this was already done at an earlier time in a manner corresponding to the earlier discussion of affinity software 160, such as when computer system 300 was initialized. The beginning of execution of affinity software 360 also causes the identification of application software 350 and a search in affinity database 369 for an entry corresponding to application software 350.

The information within that entry in affinity database 369 is used to determine whether application software 350 should be executed by one or the other of processors 310 or 315 while using only one or both of the duplicated components of the selected processor, or executed by both processors 310 or 315 while using only one or both of the duplicated components in both processors. In other words, by way of example, it may be determined that application software 350 should be executed only on processor 310 and using only processor component 311 of the duplicated components, or that application software 350 should be executed only on processor 310, but make use of both processor components 311 and 312. In other examples, it may be determined that application software 350 should be executed on both processors 310 and 315, but using only processor component 311 of processor 310 and processor component 316 of processor 315, or perhaps, both processor components 311 and 312 of processor 315 should be used, only processor component 316 of processor 315 should be used. Finally, it may be the case that application software 350 is able to benefit from as much in the way of multiprocessing capability as can be provided by computer system 300, and so all components of both processors should be used. Whichever components of processors 310 and/or 315 are used, their respective processors will read at least a portion of application software 350 from memory 325, keeping a portion of application software in those components that are used (i.e., application portions 351, 352, 356 and 357 in processor components 311, 312, 316 and 317, as appropriate) to be executed. If both processors 310 and 315 are used, or if both components within one or the other processors 310 or 315 are used, then whichever processor(s) are in use will write to and read from protocol area 359 within memory 325.

Referring variously to FIGS. 1, 2 and 3, in some embodiments, disk drives 141, 241 and 341, and supporting disk media 142, 242 and 342 provide ways by which affinity software 160, 260 and 360, respectively, could be installed and/or updated to add support for more possible variations in processing configurations and more entries to support an increased number of pieces of application software. Specifically, in typical personal computer systems, there is typically a main circuitboard to which processors, core logic and other devices are affixed, and it is common practice for processors to be socketed, making them replaceable at some future time with other processors. It is conceivable in such a circumstance that the manufacturers of the main circuitboard would provide disk media 142, 242 or 342 with affinity software 160, 260 or 360, thereon, along with affinity database 169, 269 or 369, respectively. In this way, the manufacturers of the main circuitboard could issue updates and/or new versions of either the affinity software or database as new processors become available for use with the main circuitboard. This would also allow accommodation of new processors that achieve performance gains through adding duplication of components or changing the choice of duplicated components, thereby adding or altering multiprocessor-like capabilities. Alternatively, as those skilled in the art would readily recognize, affinity software 160, 260 or 360; affinity database 169, 269 or 369; and/or updates to these could be downloaded via telephonic, network or any other form of remote access to which computer system 100, 200 or 300, respectively, might have access.

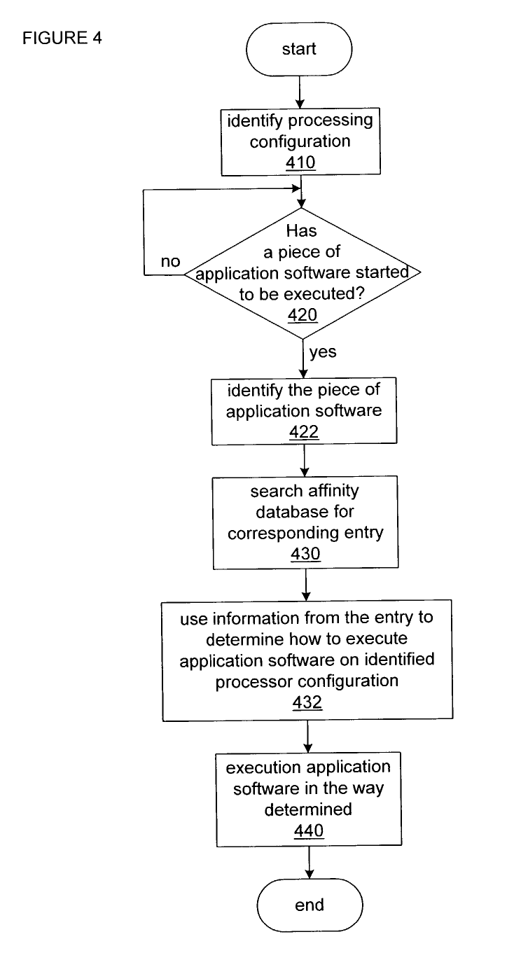

FIG. 4 is a flow chart of an embodiment of the start of execution of a piece of application software. Starting at 410, at least a portion of affinity software is executed and the processing configuration of a computer system is identified. From then on, at 420, the affinity software waits for a user or other stimulus to the computer system to cause a piece of application software to start to be executed. If a piece of application software starts to be executed, then at 422, the affinity software, perhaps in cooperation with the computer system's operating system, or perhaps as part of the computer system's operating system, identifies the piece of application software. At 430, the affinity software searches an affinity database for an entry corresponding to the application software, then at 432, uses the information from that entry to determine how to execute the application software on the processing configuration that was earlier identified. The determination of how to execute the application software could entail selecting at least one of the processors making up the processing configuration of the computer system to be used in executing the application software. Alternatively, the determination of how to execute the application software could entail selecting which duplicated components of a processor making up the processing configuration of the computer system are to be used in executing the application software. At 440, the affinity software, either working in cooperation with the operating system or as part of the operating system, causes the application software to be executed in the manner earlier determined at 432.

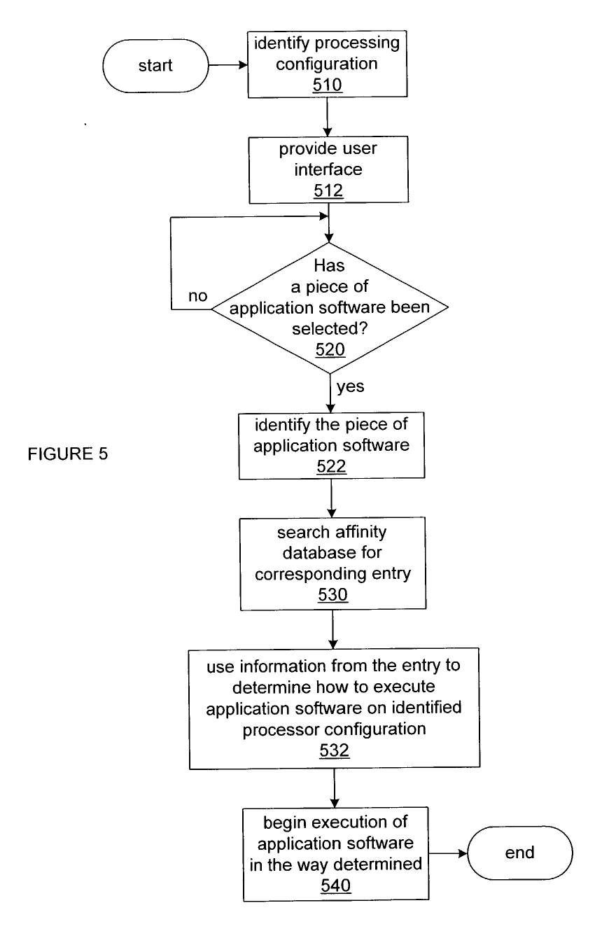

FIG. 5 is a flow chart of another embodiment of the start of execution of a piece of application software. Starting at 510, at least a portion of affinity software is executed and the processing configuration of a computer system is identified. Also, at 512, at least a portion of affinity software is executed and a user interface is provided by which a user of a computer system may select a piece of application software to be executed. From then on, at 520, the affinity software waits for a user to make a selection of which piece of application software to execute. If a piece of application software is selected, then at 522, the affinity software uses information gained through the user interface from the user to identify the piece of application software. At 530, the affinity software searches an affinity database for an entry corresponding to the application software, then at 532, uses the information from that entry to determine how to execute the application software on the processing configuration that was earlier identified. The determination of how to execute the application software could entail selecting at least one of the processors making up the processing configuration of the computer system to be used in executing the application software. Alternatively, the determination of how to execute the application software could entail selecting which duplicated components of a processor making up the processing configuration of the computer system are to be used in executing the application software. At 540, the affinity software, either working in cooperation with the operating system or as part of the operating system, causes the application software to be executed in the manner earlier determined at 532.

The teachings herein have been exemplified in conjunction with the preferred embodiment. It is evident that numerous alternatives, modifications, variations and uses will be apparent to those skilled in the art in light of the foregoing description. It will be understood by those skilled in the art that the invention as hereinafter claimed may be practiced in support of identifying and improving the performance of execution of various varieties of software beyond application software. Although embodiments have been discussed with reference to personal computer systems, it will be understood by those skilled in the art that this invention may also be practiced with regard to other varieties of computer systems. Also, although duplication of components within processors have centered on creating pairs of components, or components able to function in a manner like that of duplicated pairs of components, it will be readily apparent that such duplication can be carried out creating triplets or greater numbers of duplicates of components, thereby allowing for ever greater varieties of possible processing configurations. Furthermore, although the embodiments of multiple processing configurations have shown only configurations with two processors, it will be readily apparent that the present invention may be carried out with processing configurations of more than two processors.

What is claimed is:

1. A method comprising:
identifying a processing configuration of a computer system;
starting the execution of a piece of application software;
identifying the piece of application software;
searching for an entry corresponding to the piece of application software in an affinity database; and
using information from the entry corresponding to the piece of application software to select at least one processor of the computer system for executing the piece of application software.

2. The method of claim 1, wherein starting the execution of a piece of application software further comprises using a user interface provided by software that does the searching for an entry in the affinity database.

3. The method of claim 1, wherein the identifying the piece of application software occurs after starting the execution of the piece of application software, and further comprises awaiting the provision of identifying information by the piece of application software as the application software is executed.

4. The method of claim 1, wherein using the information from the entry corresponding to the piece of application software to select at least one processor further comprises using the information from the entry corresponding to the piece of application software to select at least one of a plurality of duplicated components within the at least one processor for executing the application software.

5. A method comprising providing a component of a computer system together with a piece of machine-accessible medium comprised of instructions that, if executed by a processor of a computer system comprised of the component, will cause the processor of the computer system to:
identify a processing configuration of the computer system;
identify a piece of application software;
search for an entry corresponding to the piece of application software in an affinity database; and
use information from the entry corresponding to the piece of application software to select at least one processor of the computer system for executing the application software.

6. The method of claim 5, wherein the machine-accessible medium is further comprised of the affinity database.

7. The method of claim 5, further comprising providing at least one update to the instructions comprising the machine-accessible medium.

8. The method of claim 5, further comprising providing at least one update to the affinity database.

9. A machine-accessible medium comprised of instructions that, if executed by a machine, will cause the machine to:
identify a processing configuration of the machine;
identify a piece of application software;
search for an entry corresponding to the piece of application software in an affinity database; and
use information from the entry corresponding to the piece of application software to select at least one processor of the machine for executing the application software.

10. The machine-accessible medium of claim 9, wherein the machine is further caused to provide a user interface to allow a user of the machine to start the execution of the piece of application software.

11. The machine-accessible medium of claim 9, wherein the machine is further caused to identify the piece of application software by awaiting the provision of identifying information by the application software after execution of the application software has begun.

12. The machine-accessible medium of claim 9, wherein the machine is further caused to use information from the entry corresponding to the piece of application software to select at least one of a plurality of duplicated components within the at least one processor of the machine for executing the application software.
